(19) United States
(12) Patent Application Publication
(10) Pub. No.: US 2009/0292098 A1
(43) Pub. Date: Nov. 26, 2009

(54) METHOD FOR PRODUCING COLOURLESS POLYISOCYANATES THAT CONTAIN BIURET GROUPS AND ARE STABLE IN STORAGE

(75) Inventors: Eva Wagner, Speyer (DE); Oliver Bey, Niederkirchen (DE); Andreas Woelfert, Bad Rappenau (DE); Joachim Jaehme, Bobenheim-Roxheim (DE); Bernd Bruchmann, Freinsheim (DE); Alexander Bayer, Limburgerhof (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF Aktiengesellschaft, Ludwigshafen (DE)

(21) Appl. No.: 11/721,506

(22) PCT Filed: Dec. 10, 2005
(86) PCT No.: PCT/EP05/13276

§ 371 Date: Jun. 12, 2007

(30) Foreign Application Priority Data
Dec. 13, 2004 (DE) 10 2004 060 120.8
Dec. 13, 2004 (DE) 10 2004 060 121.6
Dec. 13, 2004 (DE) 10 2004 060 122.4
Dec. 13, 2004 (DE) 10 2004 060 123.2
Dec. 13, 2004 (DE) 10 2004 060 131.3
Dec. 15, 2004 (DE) 10 2004 060 739.7

(51) Int. Cl. C08G 18/16; B01F 11/00

(52) U.S. Cl. 528/48; 422/224

(57) ABSTRACT

The present invention relates to a process for the preparation of colorless, storage-stable polyisocyanates containing biuret groups from di- or polyisocyanates using water and/or steam as a biuretizing agent, and an apparatus for this purpose and the use thereof.

The present invention relates to a process for the preparation of colorless, storage-stable polyisocyanates containing biuret groups from di- or polyisocyanates using water and/or steam as a biuretizing agent, and an apparatus for this purpose and the use thereof.

DE-C1 197 07 576 describes a process for the preparation of aromatic polyisocyanates containing biuret groups from isocyanates and diamines, in which diamine and isocyanate are reacted with one another in a mixing chamber and are then reacted to completion in a one-stage stirred kettle or, if appropriate, a multistage stirred kettle cascade.

EP-B1 3505 likewise describes a similar process for the preparation of polyisocyanates containing biuret groups from isocyanates and diamines, in which the amine component is metered into the isocyanate by means of a smooth jet nozzle.

The disadvantage of these two processes is that they start from amines and isocyanates as starting materials. Owing to the high reactivity of amines, the reaction with the isocyanate is difficult to control and may therefore lead to considerable formation of undesired ureas, which as a rule are poorly soluble in the reaction medium and may lead to blockages. Furthermore, these processes take place in practice at relatively high pressures and temperatures, which increases the color number of the products owing to the thermal load.

EP-A1 716 080 describes a process for the preparation of isocyanates containing biuret groups from isocyanates and water or steam, the water being introduced in finely dispersed form for controlling the reaction.

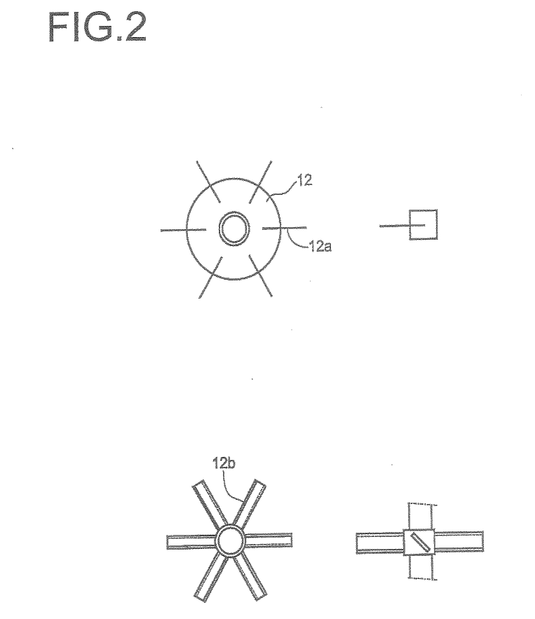

DE-A1 195 25 474 describes a process for the preparation of isocyanates containing biuret groups from isocyanates and water or steam in a cascaded reactor arrangement and by the countercurrent method. According to the embodiment shown there in FIG. 2, the catalyst is added at the top of the cascaded reactor and steam is added as a biuretizing agent at the bottom thereof via a dip tube (6A in FIG. 3 of DE-A1 195 25 474).

The disadvantage of this reaction procedure is that steam passes via the product discharge at the bottom of the reactor into downstream parts of the plant and may lead there to an uncontrolled reaction with formation of polyureas. A dip tube mounted in this manner moreover tends to blockage due to the formation of incrustations. Furthermore, in this reaction procedure, the entire dispersing energy has to be introduced into the reaction mixture by stirring, i.e. via moving components, which leads to a greater susceptibility to faults of such moving components. Moving components in turn require seals and bearings which, like dip tubes, can be changed only with difficulty, if at all, during continuous operation.

It was the object of the present invention to provide a process for the formation of biurets from isocyanates, in which water or steam is present only during the reaction and does not occur in downstream parts of the plant.

The object was achieved by a process for the preparation of polyisocyanates containing biuret groups from
a) at least one di- and/or polyisocyanate,
b) water and/or steam (water (vapor)) as a biuretizing agent,
c) and, if appropriate, at least one catalyst with liberation of carbon dioxide, comprising
i) mixing of the components a) and b) and, if appropriate, c) in a mixing means with a mixing energy of at least 0.05×10⁶ J/kg of water (vapor) and
ii) passing of the reaction mixture obtained from i) into at least one reactor in which the reaction mixture, water (vapor) and carbon dioxide are passed cocurrently or countercurrently, preferably cocurrently.

The advantage of the present invention is that no significant biuretization, which might lead to blockage in components, occurs in the product prepared according to the invention after leaving the reaction zone. Moreover, the components which are installed for carrying out the process according to the invention can be designed in such a way that they are easy to maintain and/or to replace.

In this document, the term “water and/or steam” is abbreviated to water (vapor).

Particularly suitable di- and/or polyisocyanates a) for the process according to the invention are (cyclo)aliphatic isocyanates, i.e. those compounds which have at least 2, preferably from 2 to 6, particularly preferably from 2 to 4, very particularly preferably 2 or 3 and in particular 2 isocyanate groups which are bonded to carbon atoms which are part of an aliphatic and/or cycloaliphatic system.

Suitable diisocyanates are preferably diisocyanates having 4 to 20 carbon atoms.

Aromatic isocyanates are those which comprise at least one aromatic ring system.

Cycloaliphatic isocyanates are those which comprise at least one cycloaliphatic ring system.

Aliphatic isocyanates are those which comprise exclusively straight or branched chains, i.e. acyclic compounds.

Particularly preferred aliphatic diisocyanates are tetramethylene diisocyanate, hexamethylene diisocyanate (1,6-diisocyanatohexane), octamethylene diisocyanate, decamethylene diisocyanate, dodecamethylene diisocyanate, tetradecamethylene diisocyanate, derivatives of lysine diisocyanates, tetramethylxylylene diisocyanate, 2,4,4- and/or 2,2,4-trimethylhexane diisocyanate or tetramethylhexane diisocyanate, and particularly preferred cycloaliphatic diisocyanates are 1,4-, 1,3- or 1,2-diisocyanatocyclohexane, 4,4′- or 2,4′-di(isocyanatocyclohexyl)methane, 1-isocyanato-3,3,5-trimethyl-5-(isocyanatomethyl)cyclohexane (isophorone diisocyanate), 1,3- or 1,4-bis(isocyanatomethyl)cyclohexane or 2,4- or 2,6-diisocyanato-1-methylcyclohexane. The procedure using aromatic isocyanates, in particular toluene 2,4- and/or 2,6-diisocyanate (TDI), 2,4′- and/or 4,4′-diisocyanatodiphenylmethane (MDI) and mixtures thereof, is also conceivable. Aliphatic or cycloaliphatic isocyanates are preferred, particularly preferably hexamethylene diisocyanate or isophorone diisocyanate. Mixtures of said diisocyanates may also be present.

2,2,4- and 2,4,4-trimethyl-1,6-hexamethylene diisocyanates are generally obtained as an isomer mixture in the ratio of from 1.5:1 to 1:1.5, preferably 1.2:1-1:1.2, particularly preferably 1.1:1-1:1.1 and very particularly preferably 1:1, as a result of the production.

Diisocyanates can be produced industrially, for example by phosgenation of diamines by the processes described in German Patent 20 05 309 and DE-A 2 404 773 or by a phosgene-free process (cleavage of biurethanes), as described in EP-B-0 126 299 (U.S. Pat. No. 4,596,678), EP-B-0 126 300 (U.S. Pat. No. 4,596,679), EP-A-0 355 443 (U.S. Pat. No. 5,087,739) and EP-A-0 568 782. According to the invention, whether the isocyanate used has been obtained by a phosgene-free or a phosgene-containing preparation method plays no role.

Isocyanates which originate from a phosgenation process frequently have a total chlorine content of 100-400 mg/kg, whereas the isocyanates preferred according to the invention have a total chlorine content of less than 80 mg/kg, preferably less than 60, particularly preferably less than 40, very particularly preferably less than 20 and in particular less than 10 mg/kg. The total bromine content is as a rule less than 15 mg/kg, preferably less than 10 mg/kg and especially less than 5 mg/kg. Those isocyanates which originate from a phosgene-free process are especially used.

It is also possible to make a distinction between hydrolyzable and nonhydrolyzable halogen content, the hydrolyzable proportion accounting as a rule for about 0.5-80%, preferably from 1 to 50% and particularly preferably from 2 to 30%, of the total halogen content.

The content of hydrolyzable chlorine is determined according to ASTM D4663-98 and is preferably less than 40 ppm, particularly preferably less than 30 ppm and very particularly preferably less than 20 ppm by weight.

The polyisocyanates containing biuret groups are prepared by mixing of a stream of the biuretizing agent water (vapor) into an isocyanate-containing stream and thermal treatment in at least one reactor. The isocyanate groups react with water (vapor) with formation of biuret groups, carbon dioxide (CO₂) being liberated, which carbon dioxide partly dissolves in the reaction mixture and/or may partly form a gas phase next to the reaction mixture.

Owing to the presence of the carbon dioxide in the reaction mixture, polyisocyanates containing oxadiazinetrione groups may form, depending on the catalyst used (see below). As a rule, the proportion of polyisocyanates containing oxadiazinetrione groups in the reaction mixture is less than 1% by weight, preferably 0.75% by weight, particularly preferably less than 0.5% by weight, very particularly preferably less than 0.3% by weight and in particular less than 0.1% by weight.

The reaction is preferably carried out in the presence of at least one catalyst c).

This may be, for example, OH-acidic compounds, as disclosed in DE-A1 44 43 885. These have the advantage that they are sparingly volatile and can therefore be filtered off, if appropriate as salts, from the product mixture or remain as non-interfering compounds in the end product and likewise form non-interfering decomposition products or byproducts during the reaction. A further advantage is the good catalytic activity of the acids.

Suitable OH-acidic compounds for the process according to the invention are in particular protic acids. The following can be preferably used and have proven particularly useful: phosphoric acids and/or the mono- and/or dialkyl esters or mono- and/or diaryl esters thereof and/or hydrogen sulfates. Mono- and/or dialkyl esters or mono- and/or diaryl esters of phosphoric acid whose aliphatic, branched aliphatic, araliphatic or aromatic radicals have from 1 to 30, preferably from 4 to 20, carbon atoms are preferably used. Di(2-ethylhexyl) phosphate, di(n-butyl) phosphate and dihexadecyl phosphate are preferably used.

Dibutyl phosphate and diisopropyl phosphate are particularly suitable. Di(2-ethylhexyl) phosphate is preferred.

Suitable protic acids are, for example, hydrogen sulfates, in particular tetraalkylammonium hydrogen sulfates, whose aliphatic, branched aliphatic or araliphatic radicals have from 1 to 30, preferably from 4 to 20, carbon atoms.

Further examples are sulfonic acids, such as, for example, methanesulfonic acid, ethanesulfonic acid, propanesulfonic acid, 2- and 4-toluenesulfonic acid, benzenesulfonic acid, cyclododecanesulfonic acid, camphorsulfonic acid or naphthalene-1- or 2-sulfonic acid, or mono- and dicarboxylic acids, such as, for example, formic acid, acetic acid, propionic acid, butyric acid, pivalic acid, stearic acid, cyclohexanecarboxylic acid, oxalic acid, malonic acid, succinic acid, adipic acid, benzoic acid or phthalic acid.

The (ar)aliphatic carboxylic acids described, for example, in EP-A-259 233 prove to be less effective.

Protic acids having a pKₐ value of <10 are particularly preferred. Preferred acidic catalysts are phosphoric acid or the abovementioned phosphoric esters, such as, for example, methyl phosphate, ethyl phosphate, n-butyl phosphate, n-hexyl phosphate, 2-ethylhexyl phosphate, isooctyl phosphate, n-dodecyl phosphate, dimethyl phosphate, diethyl phosphate, di-n-propyl phosphate, di-n-butyl phosphate, di-n-amyl phosphate, diisoamyl phosphate, di-n-decyl phosphate, diphenyl phosphate or dibenzyl phosphate, and mixtures thereof.

Dialkyl phosphates of said type are particularly preferred. Very particularly preferred catalysts are di-n-butyl phosphate and di(2-ethylhexyl) phosphate.

These acids are used in the process according to the invention in amounts of from 0.01 to 1.0% by weight, preferably from 0.02 to 0.5% by weight and very particularly preferably from 0.05 to 0.5% by weight, based on the total amount of diisocyanates used. The acids may be added in solution or dispersion in a suitable solvent. The acids are preferably added as such.

Said OH-acidic compounds have the advantage that they are frequently sparingly volatile and therefore, if appropriate as salts, can be filtered off from the product mixture or remain as non-interfering compounds in the end product or likewise form non-interfering decomposition products or byproducts during the reaction. A further advantage is the good catalytic activity of the acids.

For example, strong inorganic Lewis or Brønstedt acids, such as, for example, boron trifluoride, aluminum trichloride, sulfuric acid, phosphorous acid, hydrochloric acid and/or salts of nitrogen-containing bases and inorganic and/or organic acids, as described in DE-A-19 31 055, page 3, last paragraph to page 6, first complete paragraph, which is herewith incorporated by reference, can furthermore be used as the catalyst.

If desired, a small amount of a stabilizer selected from the group consisting of urea, ammonia, biuret, urea derivatives or carboxamides, as described in WO 96/25444, may also be added, preferably urea, N-methylurea, N-ethylurea, N,N-dimethylurea, N,N′-dimethylurea, N,N-diethylurea, N,N′-diethylurea, ethyleneurea or phenylurea; urea is particularly preferred.

Such stabilizers are used in amounts of 0.01-2.0, preferably 0.05-1, mol %, based on the isocyanate groups in (a).

In a preferred embodiment, these stabilizers are dissolved or dispersed in at least one solvent as mentioned below, particularly preferably in water.

In order even better to suppress the formation of insoluble polyureas, if appropriate solvents may additionally be used as solubilizers. For example, dioxane, tetrahydrofuran, alkoxyalkyl carboxylates, such as, for example, triethylene glycol diacetate, butyl acetate, ethyl acetate, 1-methoxyprop-2-yl acetate, propylene glycol diacetate, 2-butanone, 4-methyl-2-pentanone, cyclohexanone, hexane, toluene, xylene, benzene, chlorobenzene, o-dichlorobenzene, hydrocarbon mixtures, methylene chloride and/or trialkyl phosphates are suitable for this purpose.

Examples of hydrocarbons as solvents are aromatic and/or (cyclo)aliphatic hydrocarbons and mixtures thereof, halogenated hydrocarbons, esters and ethers.

Mono- or polyalkylated benzenes and naphthalenes and mixtures thereof are particularly preferred.

Preferred aromatic hydrocarbon mixtures are those which predominantly comprise aromatic C₇- to C₁₄-hydrocarbons and may have a boiling range from 110 to 300° C.; toluene, o-, m- or p-xylene, trimethylbenzene isomers, tetramethylbenzene isomers, ethylbenzene, cumene, tetrahydronaphthalene and mixtures comprising these are particularly preferred.

Examples of these are the Solvesso® grades from ExxonMobil Chemical, in particular Solvesso® 100 (CAS No. 64742-95-6, predominantly C₉ and C₁₀-aromatics, boiling range about 154-178° C.), 150 (boiling range about 182-207° C.) and 200 (CAS No. 64742-94-5), and the Shellsol® grades from Shell. Hydrocarbon mixtures comprising paraffins, cycloparaffins and aromatics are also commercially available under the names crystal oil (for example crystal oil 30, boiling range about 158-198° C. or crystal oil 60; CAS No. 64742-82-1), mineral spirit (for example likewise CAS No. 64742-82-1) or solvent naphtha (light: boiling range about 155-180° C., heavy: boiling range about 225-300° C.). The aromatics content of such hydrocarbon mixtures is as a rule more than 90% by weight, preferably more than 95, particularly preferably more than 98 and very particularly preferably more than 99% by weight. It may be expedient to use hydrocarbon mixtures having a particularly low content of naphthalene.

Methoxypropyl acetate, trimethyl phosphate, tri-n-butyl phosphate and triethyl phosphate or any desired mixtures of these compounds are preferably used according to the invention.

The reaction according to the invention is, however, preferably carried out in the absence of solvents.

The biuretizing agent b) in the process according to the invention is water and/or steam.

The water (vapor) stream may additionally comprise inert streams, for example a liquid or gaseous inert stream. The inert stream is preferably added in gaseous form. All gases which do not react substantially with the isocyanate stream, the water (vapor)-containing stream and/or the catalyst, i.e. to an extent of less than 5 mol %, preferably less than 2 mol %, particularly preferably less than 1 mol %, under the reaction conditions, are suitable as the inert medium. Examples of these are CO₂, CO, N₂, He, Ar, hydrocarbons, such as methane, etc., and mixtures thereof. Carbon dioxide and/or nitrogen are preferably used. Nitrogen is particularly preferably used.

Nitrogen/oxygen or preferably nitrogen/air mixtures having an oxygen content of less than 10% by volume, preferably less than 8% by volume and particularly preferably about 6% by volume are also conceivable.

The molar ratio of inert stream to water (vapor) stream is from 1:1000 to 1:0.1, particularly preferably from 1:100 to 1:1, very particularly preferably from 1:10 to 1:1 and in particular from 1:5 to 1:1.

Static or moving mixing means can be used as the mixing means in stage i).

Examples of these are pumps, mixing pumps, jet mixing means or gassing stirrers and combinations thereof. Jet mixing means are preferably used.

The mixing takes place as a rule at temperatures of at least 30° C., preferably of at least 50° C., particularly preferably of at least 80° C. and very particularly preferably of at least 100° C.

The upper limit of the temperature during the mixing is as a rule 250° C., preferably 190° C., particularly preferably 150° C.

The mixing time in the mixing means is preferably not more than one tenth of the total average residence time, i.e. the average time between starting and stopping of the reaction, particularly preferably not more than one twentieth, very particularly preferably not more than one thirtieth and in particular not more than one hundredth.

The mixing time in this mixing means is usually from 0.01 s to 120 s, preferably from 0.05 to 60 s, particularly preferably from 0.1 to 30 s, very particularly preferably from 0.5 to 15 s and in particular from 0.7 to 5 s. The mixing time is to be understood as meaning the time which elapses from the beginning of the mixing process until 97.5% of the fluid elements of the mixture obtained have a mixing fraction which, based on the value of the theoretical end value of the mixing fraction of the mixture obtained on reaching the state of perfect mixing, deviate from this end value of the mixing fraction by less than 2.5% (for the concept of the mixing fraction, cf. for example J. Warnatz, U. Maas, R. W. Dibble: Verbrennung, Springer Verlag, Berlin Heidelberg N.Y., 1997, 2nd Edition, page 134.)

The absolute pressure at the exit of the mixing means is in a range from 0.3 bar to 10 bar, preferably from 0.6 bar to 7 bar, particularly preferably from 0.8 bar to 5 bar.

With the use of a static mixing means, the initial pressure on the isocyanate feed side of the mixing means is from 2 to 100 bar, preferably from 4 to 60 bar, particularly preferably from 10 to 50 bar, higher than the pressure on the exit side of the mixing means.

The initial pressure on the water (vapor) feed side of the mixing means with the use of a static mixing means is from 0.2 to 20 bar, preferably from 0.4 to 10 bar, particularly preferably from 1 to 5 bar, higher than on the exit side of the mixing means.

Regardless of the type of mixing means, a mixing energy of from 0.05×10⁶ to 20×10⁶, preferably from 0.2×10⁶ to 10×10⁶, particularly preferably from 0.5×10⁶ to 7×10⁶, Joule is required per kg of water (vapor) mixed in, in order to mix in the water or the steam finely.

In the mixing means, the diisocyanate-comprising stream and the water (vapor) stream are mixed with or without inert gas.

The mixing nozzles used may be mixing nozzles which are not axially symmetrical or preferably axially symmetrical mixing nozzles. With the use of axially symmetrical mixing nozzles, one of the starting material streams is usually sprayed via a coaxial inlet pipe or a plurality of coaxially arranged inlet pipes into a mixing pipe. The second starting material stream is sprayed in via the annular gap between the coaxial inlet pipe and the mixing pipe. The ratio of the diameter of the coaxial inlet pipe to that of the mixing pipe is usually from 0.05 to 0.95, preferably from 0.2 to 0.8. The water (vapor)-containing stream can be sprayed in centrally via the inner coaxial inlet or via the annular gap. Preferably, the water (vapor) stream is introduced via the inner coaxial jet feed.

The length of the mixing pipe after the nozzle is usually from 2 to 20 times the diameter of the mixing pipe, preferably from 4 to 10 times the diameter of the mixing pipe.

The velocities in the mixing pipe are usually from 1 to 100 m/s, preferably from 5 to 30 m/s.

With the use of mixing nozzle means which are not axially symmetrical, it is possible to use mixing chamber constructions in which the starting material streams are passed into a mixing chamber and the mixture stream is removed from the mixing chamber. Further possible mixing nozzle means which are not axially symmetrical are T- or Y-mixers.

Static mixers used may be all conventional static mixers (e.g. Sulzer SMX/SMV) or nozzles or orifice mixing means.

The water (vapor) flow rate in the jet feed varies from 10 to 400 m/s, preferably from 30 to 350 m/s, particularly preferably from 60 to 300 m/s. The isocyanate flow rates vary in the jet feed from 5 to 100 m/s, preferably from 20 to 80 m/s, particularly preferably from 30 to 70 m/s.

The water (vapor) is generally used in amounts of from 0.5 to 20 mol %, preferably from 2 to 15 mol %, based on the isocyanate groups in the freshly introduced isocyanate (a).

All conventional reactors which have a volume, such as stirred kettles, jet loop reactors, bubble columns, tubular reactors, containers, or columns, may be used as the reaction apparatus. Combinations or multiple use of the apparatus types are also possible. For example, a stirred kettle can be combined with a tubular reactor. The process can also be carried out in a cascade of stirred kettles.

Advantageously, the flow in the reaction apparatus is at least partly turbulent, preferably completely turbulent.

If the reaction apparatus comprises one or more stirred kettles, the flow state is preferably adjusted so that the Newton number characterizing the power input is not inversely proportional to the Reynolds number obtained with the stirrer diameter on variation of the speed. Particularly preferably, the flow state is adjusted so that the Newton number is not dependent on the Reynolds number on variation of the speed.

If a tubular reactor without internals is employed, the Reynolds number is preferably at least 2300, particularly preferably at least 2700, very preferably at least 3000, in particular at least 4000, at least 7000 or especially at least 10 000.

Preferably, at least one stirred kettle with longitudinal flow and having a diameter to length ratio of from 1:1.2 to 1:10, preferably from 1:1.5 to 1:6, is used. In a further particularly preferred embodiment, this stirred kettle is cascaded by internals. Possible internals are perforated metal sheets, sieves, slotted trays or concentric disks, as described in DE-A1 195 25 474. By means of the internals, the stirred kettle is divided into, preferably, from 2 to 10 segments, particularly preferably into from 3 to 6 segments, which are separated from others by said internals. Of course, stirred kettles separated from one another may also be employed.

The volume-specific power input in this stirred kettle should be at least 0.1 watt/I, preferably at least 0.3, particularly preferably at least 0.5, watt/l. As a rule, up to 20 watt/l, preferably up to 6 watt/l and particularly preferably up to 2 watt/l are sufficient.

The power can be introduced via all possible stirrer types, such as inclined-blade, anchor, disks, turbines and beam stirrers. Disk and turbine stirrers are preferably used.

It is also possible to install a plurality of stirrers on the shaft. Preferably, one stirrer per segment of the cascade is used on the shaft. The diameter of the stirring elements is from 0.1 to 0.9 times the stirred kettle diameter, preferably from 0.2 to 0.6 times the stirred kettle diameter.

The stirred kettle or cascaded stirred kettle can be operated with or without baffles. Operation is preferably effected with baffles. The operation is usually effected with from 1 to 10 baffles, preferably with from 2 to 4 baffles, per segment.

The water (vapor)/isocyanate mixture is fed to the reaction apparatus. In the preferred embodiment where the reaction apparatus is an apparatus arranged predominantly vertically (for example a vertical tubular reactor, column or slim stirred kettle), the water (vapor)/isocyanate mixture can be fed in from below (cocurrent flow of the liquid phase with the CO₂) or from above (countercurrently to CO₂), preferably from below.

The CO₂ forming during the mixing or in the reactor can be removed at any point in the system. The removal is preferably effected only after complete reaction of the water (vapor).

The residence time in the reactor ii) is in the range from 0.2 to 10 hours, preferably from 0.4 to 6 hours and particularly preferably from 0.5 to 3 hours. The reaction time is advantageously chosen so that the theoretical NCO value is reached at the end. The theoretical NCO value is the NCO value which the reaction mixture has when the total amount of water (vapor) used has formed the theoretically expected amount of biuret groups.

The temperature in the region of the reaction zone is in the range from 30 to 250° C., preferably from 100 to 190° C., particularly preferably in the range from 120 to 170° C.

It may be expedient to change the temperature from segment to segment; for example, the temperature may increase along the reactor, decrease or remain the same; it preferably increases or remains the same.

The absolute pressure in the reactor is in the range from 0.3 to 10 bar, preferably from 0.6 to 4 bar, particularly preferably from 0.8 to 2 bar.

A catalyst c) is preferably added to the reaction system; thus, the catalyst stream may be mixed in separately in the reactor or at a plurality of points or into one of the streams which are fed to the mixing nozzle. The catalyst is preferably mixed into one of the streams which are fed to the mixing nozzle. Particularly preferably, the catalyst stream is fed into the stream comprising isocyanate groups which enters the mixing means.

In the simplest embodiment, the invention comprises the combination of mixing means i) and reactor ii). Here, the isocyanate stream, with or without catalyst c), is then mixed with the water (vapor)-containing stream b) and then introduced into the reactor ii). The mixing means i) and the reactor ii) need not be separated; instead, the reactor may also be directly connected to the mixing means.

In the mixing means ii), the reaction can begin immediately after mixing of the components, so that the reaction is not necessarily limited to the reactor.

A further embodiment of the invention comprises establishing a mixing circulation comprising a pump for circulating the isocyanate/polyisocyanate mixture, if appropriate provided with pump reservoir and/or mixing means.

A mixing circulation is understood as meaning a pumped circulation which comprises at least one pump and at least one mixing means, for example static mixers and/or mixing elements, and into which at least one of the components to be mixed is metered, preferably upstream of the pump. The pumped circulation can moreover comprise a pump reservoir. The pumped circulation may furthermore comprise at least one heat exchanger.

The pump sucks the isocyanate-containing stream out of the pump reservoir and transports it to the mixing means, from where it is fed back to the pump reservoir. A part of the circulation stream can be taken off from the circulation, preferably between mixing means and reservoir, and passed into the reactor ii).

Alternatively or additionally, the fresh isocyanate and catalyst may also be fed into the reactor, preferably at the beginning of the reactor, particularly preferably into the first 25% of the reactor zone, very particularly preferably into the first 10%. The mixing then takes place within the reactor and, if appropriate, additionally by virtue of the fact that a part-stream is removed from the reactor at any desired point and is fed into the mixing circulation.

In a preferred embodiment, catalyst can also be fed in at a plurality of points of the reactor and/or mixing circulation.

Before the stream enters the mixing means, the fresh isocyanate stream is added to the isocyanate-containing stream. In order to promote the mixing of the fresh isocyanate stream into the isocyanate-containing pumped stream, a static mixing means or another mixing means can be used.

In the mixing means, the isocyanate-containing stream and the water (vapor)-containing stream are then mixed. In the embodiment as a mixing circulation, the discharge from the mixing means is at least partly transported back into the pump reservoir. The remaining part-stream for the discharge is transferred into the reactor. The use of the pump reservoir is not essential, but it facilitates pump operation with expedient regulation.

A preferred embodiment of the invention comprises the combination of a mixing circulation with the reactor. For this purpose, an isocyanate-containing stream is removed from the reactor via a pump and transported to the mixing means. In the mixing means, the water (vapor)-containing stream is mixed in. The stream emerging from the mixing means is recycled into the reactor. The catalyst stream and the fresh isocyanate stream are either fed to the isocyanate-containing stream upstream of the mixing nozzle and/or directly passed into the reactor.

In a particularly preferred embodiment, the reactor comprises a cascaded stirred kettle. The isocyanate solution which is transported to the mixing means is removed from the lowermost segment of the cascaded stirred kettle.

According to a particularly advantageous embodiment of the process according to the invention, the distribution of the gaseous fraction in the liquid reactant is improved by baffles installed in the stirred reactor. Disks arranged a distance apart and provided with central orifices can be used as separating elements between the individual segments. In addition, baffles running in the longitudinal direction of the stirred reactor may be used. From 10 to 95% by volume of nitrogen and/or carbon dioxide may be mixed with the reactant, preferably water vapor, fed in as biuretizing agent. For the reaction, a temperature of from 60 to 200° C., preferably from 100 to 150° C., is established. Preferably, the waste gas flowing away at the top end of the stirred reactor is washed with diisocyanate, which can be precooled to a temperature of about 0 to 20° C., but need not necessarily be. The diisocyanate discharged from the wash step is then fed to the process. Such washing of the waste gas with fresh isocyanate reduces deposits of polyurea residues in the waste gas system.

According to the invention, a stirred reactor which has a perpendicular tubular container in which a drive axle to which at least two disk stirrers are fastened a distance apart is rotatably fastened parallel to the longitudinal axis and in which separating elements which have a central orifice are arranged between these disk stirrers on the inner surface of the container is provided for carrying out the process. It has been found that, depending on the reaction parameters, expediently from 2 to 7 disk stirrers and from 1 to 6 separating elements are used. The ratio of the orifice of the separating elements to the total area thereof depends on the stirrer size.

According to a further development of the stirred reactor according to the invention, baffles running parallel to its longitudinal axis and extending radially inward can be arranged on the inner surface of said stirred reactor. These can be fastened preferably at a distance to the inner surface of the reactor. Advantageously, at least 2, preferably 2-6, particularly preferably from 2 to 4 and very particularly preferably 2, 3 or 4, baffles arranged at the same angular distance apart are provided. In their width, the baffles may be 0.1-0.4 times the diameter of the container.

Furthermore, It may be expedient to provide unstirred segments in the reactor (calming zones). In a preferred embodiment of the invention, such calming zones may be present at the entrance and/or exit and are particularly present at the entrance and exit.

The stirred reactor may be enclosed by a heatable jacket or welded-on full or half pipes. The top end of the stirred reactor is advantageously connected to a container (waste gas scrubber) in the lower part of which a condenser may be installed. Above this condenser is an injector for the liquid reactant. This unit opens into a waste gas pipe.

The ratio of the height of the stirred reactor to the diameter thereof is advantageously in the range from 2 to 6 and is preferably greater than 4.5.

With reactors of the design described above, the process according to the invention can be particularly advantageously carried out.

Further details and advantages of the invention appear in the description of the pilot plant shown in the drawing.

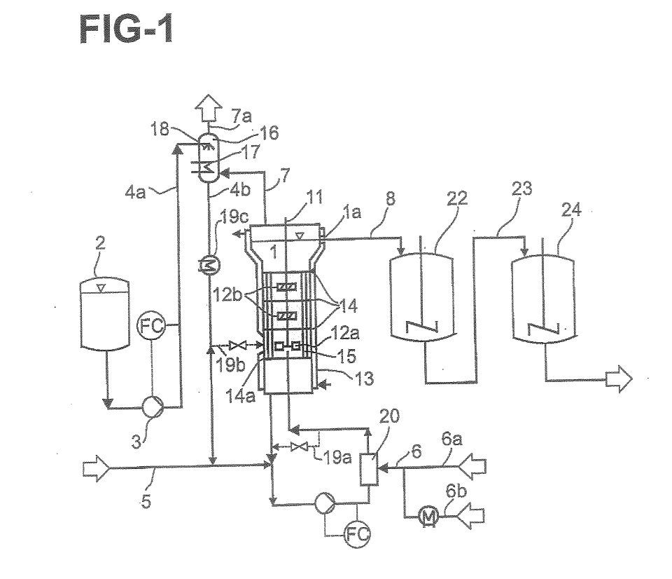

FIG. 1 shows a plant according to the invention comprising a cascade-like stirred reactor,

FIG. 2 shows a plan view of a disk and inclined-blade stirrer arranged in the stirred reactor.

In the plant shown in FIG. 1, the reaction for the preparation of, preferably, (cyclo)aliphatic polyisocyanates containing biuret groups is effected in a stirred reactor 1 and a mixing circulation. Isocyanate, for example hexamethylene diisocyanate (HDI), as one of the two reactants is fed to the latter from a container 2 via a pump 3 through a pipe 4a/b. Catalysts can be fed in through pipe 5 which, as shown, can be combined with pipe 4b or led separately from this to the mixing circulation. In the mixing circulation, if appropriate steam 6a diluted with gaseous nitrogen 6b is fed in as the second reactant through pipe 6. In the reactor, the waste gases forming during the reaction, in particular CO₂, are removed from the top of the stirred container 1 through the pipe 7. The product forming during the reaction, i.e. the polyisocyanate having biuret groups, is removed from the upper end of the container 1 through pipe 8 and fed via a pump 9 (not shown) or preferably by means of an overflow to the collecting container.

Stirrers 12 rotatable about a perpendicular axis 11 are arranged in the stirred container 1. The temperature in the stirred container 1 is adjusted by a heatable jacket 13 surrounding said container.

The stirred container denoted by 1 has a cascade-like form (cascaded stirred container), in this container, a disk stirrer 12a and two segments stirred by inclined-blade stirrers 12b are on the axis 11 of rotation parallel to the longitudinal axis of the container 1. Present between them are two separating elements 14 which are arranged a distance apart and fastened to the wall of the stirred container 1 and have a circular central orifice. Furthermore, unstirred segments (calming zones) separated in each case by separating disks 14 and 14a are present before (at the reactor entrance) and after (at the reactor exit) the stirred segments.

In the embodiment shown, the stirred container 1 has an internal diameter of 682 mm. The orifices in the baffle plates may have different orifices. Thus, the orifice in the separating elements 14 has a diameter of 240 mm and that in the baffle plate 14a has a diameter of 480 mm. The disk stirrers 12a, one of which is shown in FIG. 2, may have different dimensions. As a rule, standard disk stirrers are used. In the present case, the disk of the lower disk stirrer 12a has a diameter of 210 mm. The external diameter, including the perpendicular stirring surfaces 12A, is 280 mm. The stirring surfaces 12A are rectangular and have a height of 56 mm and a width of 70 mm.

The inclined-blade stirrers used have a total diameter of 340 mm with six blades which are arranged uniformly around the axis 11 of rotation and in each case are staggered by an angle of 45° relative to the plane of rotation.

In the interior of the stirred container 1, four baffles 15 are arranged parallel to the longitudinal axis of the stirred container at an angular distance of 90° each and with a wall spacing of 14 mm. The axis 11 of rotation with the stirrers 12a and 12b arranged on it rotates at from 60 to 400 revolutions per minute.

The reactant HDI is fed to the mixing circulation from the container 2 with the aid of the pump 3 through the pipe 4a/b. The pipe 4 may lead via an injector 18, initially into a wash container 16 which has a condenser 17. By means of this condenser, the waste gas flowing in from the stirred container 1 via the pipe 7 and flowing away through the pipe 7A can be cooled and condensable fractions can be condensed. Deposition of residues in the pipe 7 is prevented thereby. The waste gas substantially comprising CO₂ flows away out of the upper part of the cooling container 16 through pipe 7a and can be passed, for example, into an incineration means, if appropriate after an alkaline wash.

The steam/nitrogen mixture fed through pipe 6 into the mixing circulation is passed into the mixing means 20. In the embodiment shown in FIG. 1, this is effected in a manner such that the pipe 6 enters the nozzle 20 as a mixing member, in which mixing with the HDI/catalyst mixture is effected.

In the mixing apparatus (nozzle) 20, the biuretizing agent, steam as a mixture with nitrogen in the volume ratio of 1:0.5, is mixed, via the pipe 6, with an isocyanate-containing stream, into which catalyst is additionally metered via the pipe 5, with a dispersing energy of 2×10⁶ W/kg of steam, in a concentrated mixing nozzle in which isocyanate is introduced on the outside and steam on the inside. The isocyanate-containing stream may be pure fresh isocyanate which originates directly from the wash container 16 or a reaction mixture which is removed from the stirred container 1, preferably from a calming zone at the beginning of the reactor, or a mixture of fresh isocyanate from wash container 16 with a reaction mixture from stirred container 1 (preferred embodiment) or a product circulated via the pipe 19a (shown as a dashed line in FIG. 1). Freshly fed in isocyanate and the catalyst can be metered together or separately into the circulation and/or fed into the reactor (pipe 19b, shown as a dashed line in FIG. 1). The freshly fed in isocyanate can, if required, be preheated in a heat exchanger 19c, preferably to reaction temperature.

The volume ratio of circulated isocyanate-containing stream to fresh isocyanate-containing stream is as a rule 10-1001:1, preferably 10-50:1. In a preferred embodiment, the temperature in the circulation is 130-145° C., particularly preferably about 140° C.

The product is removed from the upper end of the stirred container 1 at 1 A and can be fed to a collecting container (not shown) by means of an overflow via the pipe 8.

In a particularly preferred embodiment of the invention, the plant, as shown in FIG. 1, can be operated with at least one downstream reactor by thermally after treating the product discharged from the reactor 1 via the pipe 8 in a further reaction stage iii) in at least one downstream reactor 22.

Compared with the reaction in the reactor 1 in stage ii), this downstream reaction is distinguished by the fact that the carbon dioxide forming in the reaction has already been substantially separated off from the reaction mixture, i.e. to an extent of at least 80% by weight, preferably at least 85% by weight, particularly preferably at least 90, very particularly preferably at least 95 and in particular at least 98% by weight. This downstream reactor 22 may be a single stirred reactor or a cascade of a plurality of stirred reactors, for example, as shown, two stirred reactors 22 and 24, or a tubular reactor.

In the downstream reaction zone, the product transported from the reactor 1 by pipe 8 is thermally aftertreated at a temperature from 80 to 180° C. for a residence time of from 1 to 4 hours. By means of this measure, the color number and/or the storage stability of the product containing biuret groups can be improved and furthermore, if required, the desired oligomer distribution and viscosity can be established. Furthermore, CO₂ still remaining in the reaction mixture is expelled in the aftertreatment.

The products prepared according to the invention are distinguished by an improved storage stability, which means that a smaller proportion of monomers is eliminated by cleavage from the polyisocyanate containing biuret groups compared to that known from the prior art.

The plant according to the invention can be operated continuously and semicontinuously. In the semicontinuous procedure, HDI and catalyst are initially taken and heated. The mixture of steam and nitrogen is then passed in continuously. The reaction takes about 3 to 4 hours altogether.

In the continuous procedure, HDI and catalyst are metered continuously into the mixing circulation and at the same time the mixture of steam and nitrogen is passed in. The crude product comprising HDI-biuret oligomers and excess monomers is discharged continuously via pipe 8. The crude product is then worked up by means of distillation.

In order to obtain products which do not liberate any hazardous amounts of isocyanates on processing, it will generally be necessary to separate off the major part of the unconverted isocyanates (a) from the resulting polyisocyanates containing biuret groups. In general, products whose content of the monomeric isocyanates (a) is less than 1, preferably less than 0.75, % by weight, particularly preferably less than 0.5 and very particularly preferably less than 0.3% by weight, based on the polyisocyanates containing biuret groups, are desired. The isocyanates (a) are advantageously separated off under reduced pressure at temperatures which are from 50° C. to the reaction temperature chosen for the reaction, for example by distilling them off, preferably in thin-film evaporators.

Apparatuses used for this purpose are flash, failing-film, thin-film or short-path evaporators, to which, if appropriate, a short column may be attached.

The distillation is effected as a rule at a pressure of from 0.1 to 300 hPa, preferably under 200 hPa and particularly preferably under 100 hPa.

The process described according to the invention gives, as a rule, products which have a color number of less than 20 APHA according to DIN ISO 6271 and/or a viscosity of from 1000 to 10 000 mPas according to DIN 53019 Part 1 (rotational viscometer).

In addition to polyisocyanates containing biuret groups, minor amounts of polyisocyanates containing uretdione and/or allophanate groups may also be comprised. The proportion of such polyisocyanates is in each case less than 5% by weight, particularly preferably less than 3, very particularly preferably less than 2, in particular less than 1 and especially less than 0.5% by weight.

In the coating industry, polyisocyanates containing biuret groups and having a viscosity of from 2000 to 20 000, preferably from 2500 to 15 000 and particularly preferably from 3000 to 12 000, mPa·s (based on a solids content of 100%, measured at a temperature of 23° C. and a shear gradient of 100 s⁻¹), are desired above all. Such polyisocyanates can, if required, be diluted with solvents, for example the abovementioned ones, preferably butyl acetate, xylene or methoxypropyl acetate.

The products obtained by the process according to the invention are particularly suitable as curing agents in the coating industry. The processing of these curing agents to give finishes and coatings produced therefrom is generally known.

### EXAMPLES

In the plant shown in FIGS. 1 and 2 and described above, hexamethylene 1,6-diisocyanate (HDI) was biuretized at 140° C. in the presence of a steam/nitrogen mixture while circumventing the pipes 19a and 19b. The average residence time in the reactor 1 was about 4 hours. 4 kg of catalyst were added per 1000 kg of HDI.

The reaction mixture thus obtained was then aftertreated over a further 4 hours in containers 22 and 24 at about 140° C. and unconverted HDI was then removed by distillation so that the content of free HDI stated below was obtained.

A polyisocyanate prepared according to the invention, containing biuret groups and based on hexamethylene 1,6-diisocyanate (HDI) was stored at room temperature for several months and the content of free HDI was determined (by gas chromatography according to DIN 55956).

The following values were found:

| | Free HDI [% by weight] |
|---|---|
| Before storage | 0.28 |
| After 3 months | 0.28 |
| After 6 months | 0.28 |

The measurement series was repeated at a storage temperature of 50° C.:

| | Free HDI [% by wt.] |
|---|---|
| Before storage | 0.10 |
| After 1 week | 0.09 |
| After 2 weeks | 0.15 |
| After 3 weeks | 0.16 |
| After 4 weeks | 0.17 |
| After 2 months | 0.20 |
| After 3 months | 0.21 |
| After 6 months | 0.38 |
| After 9 months | 0.30 |

A procedure analogous to DE-A1 195 25 474 gave a higher content of free HDI during storage.

1. A process for the preparation of polyisocyanates containing biuret groups from
a) at least one di- and/or polyisocyanate,
b) water and/or steam (water vapor) as a biuretizing agent,
c) and, optionally, at least one catalyst with liberation of carbon dioxide,
said process comprising the reaction steps of
i) mixing the components a) and b) and, optionally, c) in a mixing means with a mixing energy of at least 0.05×10⁶ J/kg of water (vapor) and
ii) passing of the reaction mixture obtained from i) into at least one reactor in which the reaction mixture, water (vapor) and carbon dioxide are passed cocurrently or countercurrently.

2. The process according to claim 1, wherein the reaction mixture, water (vapor) and carbon dioxide are passed cocurrently.

3. The process according to claim 1, wherein the temperature in step ii) is from 100 to 190° C.

4. The process according to claim 1, wherein the average residence time in step ii) is from 0.4 to 6 hours.

5. The process according to claim 1, wherein the mixing time in the mixing apparatus is from 0.05 to 60 s.

6. The process according to claim 1, wherein, after at least 80% of the liberated carbon dioxide has been separated off, the reaction mixture from step ii) is thermally aftertreated at a temperature of from 80 to 180° C. for a residence time of from 1 to 4 hours.

7. An apparatus comprising
at least one mixing means
a pumped circulation into which isocyanate, catalyst, water (vapor) and, optionally, inert gas can be passed directly or in combination via feed pipes,
a downstream cascaded stirred reactor having from 2 to 10 stirred segments into which a circulated product is transported, and,
at least one calming zone for gas-liquid separation.

8. The apparatus according to claim 7, additionally having
at least one downstream reactor into which the liquid phase from the calming zone can be passed.

9. The preparation of polyisocyanates containing biuret groups by means of an apparatus according to claim 7.

10. The preparation of polyisocyanates containing biuret groups by means of an apparatus according to claim 8.
